(19) United States
(12) Patent Application Publication
(10) Pub. No.: US 2002/0038281 A1
(43) Pub. Date: Mar. 28, 2002

(54) Method and a system for offering for sale of a product

(76) Inventors: Kim Lohmann, Lyngby (DK); David Choleva, Hellerup (DK); Anders Gerhardt, Bagsvaerd (DK); Denis Lewinsky, Charlottenlund (DK)

Correspondence Address: BIRCH STEWART KOLASCH & BIRCH, PO BOX 747, FALLS CHURCH, VA, 22040-0747, US

(21) Appl. No.: 09/951,541

(22) Filed: Sep. 14, 2001

Related U.S. Application Data
(60) Provisional application No. 60/232,428, filed on Sep. 14, 2000.

(51) Int. Cl. G06F 17/60

(52) U.S. Cl. 705/37

(57) ABSTRACT

A method for offering for sale of a product, the method being performed under the control of a first computer system connected to a computer network, the method comprising collecting, via the computer network, information from a plurality of potential purchasers of the product, the information including for each of the potential purchasers: identification data identifying the purchaser; purchase-condition influencing the conditions under which the product is going to be offered to the purchaser; defining at least two groups of potential purchasers; the purchasers in each group having at least one purchase-condition influencing data in common; generating, based at least on said common purchase-condition influencing data of each of the groups, at least one condition under which the product is offered for sale to the potential purchasers of each group; forwarding information containing said at least one condition to each of the potential purchasers.

### TECHNICAL FIELD

The present invention relates to a method for offering for sale of a product, the method being performed under the control of a computer system connected to a computer network, such as the Internet. The invention further relates to a method for offering a plurality of products for sale, and to a system for performing the methods of the invention. In particular, the invention relates to a method and a system making use of the so-called “group-buying concept” which exploits the benefits and advantages available to a plurality of potential purchasers of a product when placing a common purchasing order.

### BACKGROUND OF THE INVENTION

Various methods for using computer networks for placing purchasing orders have been proposed in the prior art.

EP 0 902 381 A2 assigned to Amazon.Com, Inc. discloses a method and a system for placing an order to purchase an item via the Internet. The order is placed by a purchaser at a client system and received by a server system. The server system receives purchaser information including identification of the purchaser, payment information, and shipment information from the client system. The server system then assigns a client identifier to the client system and associates the assigned client identifier with the received purchaser information. The server system receives the request and combines the purchaser information associated with the client identifier of the client system to generate an order to purchase the item in accordance with the billing and shipment information whereby the purchaser effects the ordering of the product by selection of an order button.

In EP 0 736 846 B1 assigned to Bellboy International A/S, a method has been proposed in which ordering is performed via a user terminal connected to a central data processing device. A service request is specified and information of a service is retrieved from a base in the central data processing device. When a given service offer is selected, a connection is automatically established between the user terminal and a service location terminal via the central data processing device, whereupon the desired service can be ordered an the order confirmed. Further orders can be placed before the connection is broken. When an order has been made the data base is automatically updated from the service location.

### DESCRIPTION OF THE INVENTION

It is an object of the present invention to provide a method and a system for offering for sale of a product which makes it easier for a potential purchaser of the product to obtain a price reduction by placing a request for an offer for the product in a group together with other potential purchasers. It is a further object of the invention to provide a method and system which allows the offer for the product to be dependent on certain information related to the potential purchasers of the product, such as living area or age of the potential purchasers. It is a still further object of the invention to provide a method and system which allows the potential purchasers to effectively compare prices and possibly other sale conditions of the product from a plurality of entities offering the same product or similar products for sale, such as for example insurance, telephone, bank products or services, such as loan products.

Thus, in a first aspect the invention provides a method for offering for sale of a product, the method being performed under the control of a first computer system connected to a computer network, the method comprising:

collecting, via the computer network, information from a plurality of potential purchasers of the product, the information including for each of the potential purchasers:

identification data identifying the purchaser,

purchase-condition influencing data influencing the conditions under which the product is going to be offered to the purchaser,

defining at least two groups of potential purchasers, the purchasers in each group having at least one purchase-condition influencing data in common,

generating, based at least on said common purchase-condition influencing data of each of the groups, at least one condition under which the product is offered for sale to the potential purchasers of each group, the at least one condition possibly including the price of the product,

forwarding information containing said conditions to each of the potential purchasers.

The computer system may comprise a server system and/or one or more personal computers. The computer network may comprise a WAN, such as the Internet, or a LAN, such as the Intranet of a company or institution. The potential purchasers are typically users of the Internet who have access to a site on the Internet at which one or more products are offered for sale. The products offered for sale are typically products or services, the prices of which are difficult to compare for a potential purchaser due to inscrutability, as the price of a product, like for instance a telephone line subscription, is composed of a number of parameters, such as local and long distance calling rates, a fixed subscription fee, reduced calling rates on certain days and/or at certain hours, etc.

Typical products of these kinds are insurance products, stationary or mobile telephone lines or telephone subscriptions, other communication products or services, such as cable or satellite television, Internet services, credit card services or products, news papers, unemployment funds or insurance, loans, such as bank loans or real-estate loans, pensions, gasoline, heating oil, electricity, gas, such as natural gas. Further products which may be offered for sale in the method according to the invention may comprise clothing, everyday necessities, books, electronic devices such as computers, entertainment electronics such as hifi devices or televesions, books, audio or video carrying media, and furniture.

It will be understood that the method according to the invention allows, under control of the computer system, to request an offer for a certain product on behalf of a plurality of potential purchasers. Thus, a plurality of individual potential purchasers are allowed to obtain a price reduction due to the fact that a plurality of identical products are being ordered simultaneously by a plurality of potential purchasers. The method also allows a supplier of the product to offer individual purchasing conditions, such as individual prices, to individual groups of purchasers. Thus, for example a higher price can be set for an insurance for a purchaser/policyholder which predictably is a high-risk purchaser. In a different example, a lower price can be set for a strategically important potential purchaser. Thus, the method of the present invention may for example be used by suppliers of a given product or service, for example a telephone subscription, to offer lower prices in a given geographical area where the supplier wishes to increase his market share.

The step of collecting information from a plurality of potential purchasers is preferably carried out by means of windows and/or menus displayed to the potential purchasers at the Internet site. The identification data identifying the purchaser may relate to the name of the purchaser or may comprise data related to an electronic mail or site address of the purchaser, such as for example an e-mail address. The purchase-condition influencing data are typically data which influence the price of the product, such as an insurance or a bank loan. For example, the conditions under which the insurance for a car is offered to the potential purchaser is typically dependent on accident or damage statistics of the owner of the car, the age and sex of the owner, the living area of the owner, etc.

Generally, for any kind of product offered for sale, the identification data and the purchase-condition influencing data may comprise given name, surname, street, number of a house, floor, zip code, city, occupation, date of birth, sex, telephone number, marital status. The same data may be used for any possible children of the potential purchaser.

In case the product offered for sale is a household insurance, the identification data and the purchase-condition influencing data may further or alternatively comprise one or more of the following: value of household goods, own risk or franchise, value, type and age of bicycle, request for coverage for electrical damages, request for travel insurance, request for coverage for glass and basin items, request for special golf coverage, number, type and age of possible dogs.

In case the product offered for sale is a residence, the purchase-condition influencing data may further or alternatively comprise one or more of the following: zip code, residence area, year of construction, own risk or franchise, request for fire coverage, request for hull, request for coverage for fungi damage, request for coverage for damage caused by bugs, request for coverage for glass and basin items, request for coverage for electrical installations, request for coverage for pipes and cables, information related to type of roof.

In case the product offered for sale is a vehicle insurance, the purchase-condition influencing data may further or alternatively comprise one or more of the following: brand and model of the vehicle, size of engine, construction year of the vehicle, value of a corresponding new vehicle, earliest registration date, field of usage of the vehicle, age of owner or user, owner's or user's number of years without damage, possible date(s) of past damage(s), owner's or users zip code, hull value, own risk or franchise, request for hull, request for driver's seat coverage, request for free damage coverage, request for stepwise coverage, request for privation coverage, request for accident insurance, value of accident insurance, request for special winter coverage.

In case the product offered for sale is a boat, the purchase-condtion influencing data may further or alternatively comprise one or more of the following: type of boat, harbour, year of construction, number of owner's or user's years without damage, information related owner's or user's nautical examinations, insurance value.

In case the product offered for sale is an accident insurance, the purchase-condition influencing data may further or alternatively comprise one or more of the following: request for coverage for co-policyholder, request for children's coverage, age and occupation of policyholder, special sport activities of policyholder, employee status, number of working hours per week, possible death coverage and coverage value, possible invalidity coverage and coverage value, full time or part time coverage, request for tooth damage coverage, request for motor cycle coverage, supplementary coverage, private air plane coverage.

In case the product offered for sale is a travel insurance, the purchase-condition influencing data may further or alternatively comprise one or more of the following: request for travel insurance, request for annual travel insurance, travel destination, date of departure, date of home journey, number of persons, age of each person, request for travel cancellation coverage.

In case the product offered for sale is a telephone line or telephone subscription, the purchase-condition influencing date may further or alternatively comprise one or more of the following: identification of present supplier of requested services/products, present telephone number, identification of present subscription, current quarterly invoicing from present supplier, frequency of calls to countries abroad, identification of most frequently called countries.

In case the product offered for sale is gasoline, the purchase-condition influencing data may further or alternatively comprise one more of the following: identification of requested gasoline supplier, monthly gasoline consumption, possible remarks.

In case the product offered for sale is heating oil, the purchase-condition influencing data may further or alternatively comprise one more of the following: identification of requested oil supplier, quantum, earliest date of delivery, latest date of delivery, location of oil container, possible remarks.

Some of the above data may be entered as text streams, some as boolean variables, and some may be entered as numerical values. For some of the above data, a table containing predetermined values or text streams may be displayed to the potential purchaser. The purchaser may then be allowed to select a value from the table, e.g. by mouse-clicking on the appropriate value. Other data may be entered by selected “yes” or “no” in a dialogue box displayed to the potential purchaser.

The at least one common purchase-condition influencing data of a group may defined by an interval. Thus, for example a first group may consist of potential purchasers residing in an area with zip code lower than 2000, a second group of potential purchasers may consist of potential purchasers residing in an area with zip code from 2000 and lower than 4000, and a second group of potential purchasers may consist of potential purchasers residing in an area with zip code higher than 4000. In each group, the potential purchasers may have more purchase-condition influencing data in common. In case of the product being a telephone or communications product, the common purchase-condition influencing data or the interval may also define the number of minutes or hours the potential purchasers make use of a communications line for various purposes, such as number and/or duration of local calls per week/month, number and/or duration of long-distance calls per week/month, number and/or duration of calls to a first group of foreign countries per week/month, number and/or duration of calls to a second group of foreign countries per week/month, etc.

In the step of generating the condition under which the product is offered for sale to the potential purchasers, a set of conditions for each group is generated. Thus, for example one group of potential vehicle insurance purchasers may comprise females, and another group may comprise males. If the number of potential purchasers who have signed up for a similar product increases, finer groupings are possible. Thus, for example potential purchasers of a vehicle insurance can be grouped in:

males of the age of 30 years or more living in a high-risk area,

males of the age of 30 years or more living in a low-risk area,

males under the age of 30 living in a high-risk area,

males under the age of 30 living in a low-risk area,

females living in a high-risk area,

females living in a low-risk area.

In a preferred embodiment of the invention, the steps of:

defining the groups of potential purchasers,

generating the conditions under which the product is offered for sale, and

forwarding information containing the conditions,

are performed when information from a first predetermined number of potential purchasers has been collected and/or when information has been collected for a first predetermined time interval, and wherein said steps are repeated when information from a second predetermined number of potential purchasers has been collected and/or when information has been collected for a second predetermined time interval.

Preferably, the definition and the number of the groups is different each time the groups are generated. Thus, a first set of groups may be generated when the first predetermined number of potential purchasers has been registered for a given product or service. If for example, information has been collected from 20 potential purchasers, two groups may be defined, for example males and females, and the conditions under which the product is offered for sale to those two groups are generated and forwarded to the potential purchasers. If information from another 10 potential purchasers is collected, the total number of 30 potential purchasers may be grouped in 3 groups, for example men of the age of 30 years or more, men under the age of 30 years, and females. If information from another 10 potential purchasers is collected, the total number of 40 potential purchasers may be grouped in 4 groups, etc. Likewise, information may be collected during a first predetermined time interval, e.g., 2 hours, 1 day, 2 days, 1 week, 1 month, and repeated after a second predetermined time interval. A combination of time intervals and number of potential purchasers may be applied, such that the groups are generated when information from a predetermined number of potential purchasers has been collected irrespective of the time elapsed, and such that when a predetermined time has elapsed, groups are generated irrespective of the number of potential purchasers from whom information has been collected.

Typically, the more often the above steps are repeated, the more purchase-condition influencing data are in common between the potential purchasers of each group.

The first and second predetermined numbers may be constant or be variable. They may, for example be a function of one or more parameters, such as type of product, number of potential purchasers from whom information has previously been collected, and/or number of times purchase conditions have previously been generated.

The step of forwarding information containing the conditions may be performed by means of mail, such as electronic mail or conventional mail.

The step of generating said conditions may be performed by means of a second computer system connected to the computer network, in which case the method preferably comprises:

subsequent to the step of defining the at least two groups and prior to the step of generating the conditions: passing to the second computer system information containing the number of purchasers in each group and the common purchase-condition influencing data,

receiving, at the first computer system, from the second system the conditions under which the product is offered for sale.

The second computer system may be controlled by an entity offering said product for sale, such as for example an insurance company if the product is an insurance product or a communication services company if the product or service offered for sale is a telephone line subscription.

The first computer system may be connected to a plurality of second computer systems at entities offering the same product or similar products for sale. Thus, the information containing the number of purchasers in each group and the common purchase-condition influencing data may be passed to a plurality of second computer systems, and conditions may be received from the plurality of second computer systems. This allows for a selection between different offers for the same product or similar products. The selection may be made under control of the first computer system, in which case only conditions from one of the second computer systems is forwarded to the potential purchaser.

Alternatively, the choice may be given to the potential purchaser which is presented to all or some of the conditions of the different suppliers.

The one or more second computer systems may consist of software integrated in a co-operating with the first computer system. The first and second computer systems may comprise or run on the same or on different hardware items.

In a second independent aspect of the present invention, the method described above may be applied for offering for sale of a plurality of product. Thus, the method according to the second aspect of the invention may be performed under the control of a first computer system connected to a first computer network, the method comprising:

receiving a user selection of at least one of the products by a plurality of potential purchasers of the product, and

performing the method according to the first aspect of the invention for each of the products.

At least two groups of potential purchasers are preferably defined for each group.

Any and all of the features and functionalities described above in relation to the first aspect of the invention may be applied in the method according to the second aspect of the invention.

In a third aspect, the present invention relates to a system for offering a product for sale, the system comprising a computer network and a first computer system connected to the computer network, the system being adapted to:

collect, via the computer network, information from a plurality of potential purchasers of the product, the information including for each of the potential purchasers:

identification data identifying the purchaser,

purchase-condition influencing data influencing the conditions under which the product is going to be offered to the purchaser,

define at least two groups of potential purchasers, the purchasers in each group having at least one purchase-condition influencing data in common,

generate, based at least on said common purchase-condition influencing data of each of the groups, at least one condition under which the product is offered for sale to the potential purchasers of each group, said condition possibly including the price of the product,

forward information containing said conditions to each of the potential purchasers.

The system may further be adapted to:

define the groups of potential purchasers,

generate the conditions under which the product is offered for sale, and

forward information containing the conditions,

when information from a first predetermined number of potential purchasers has been collected, and the system may comprise a data processor which is programmable to repeat defining, generating and forwarding when information from a second predetermined number of potential purchasers has been entered into the system.

A second computer system may be provided which is connected to the computer network, the first computer system being adapted to:

pass, to the second computer system, information containing the number of purchasers in each group and the common purchase-condition influencing data,

receive, from the second computer system, the conditions under which the product is offered for sale.

The second computer system may be controlled by an entity offering said product for sale. A plurality a second computer systems at a plurality of entities offering the product for sale may be provided. The first computer system may be adapted to forward, to the potential purchasers, information containing said conditions received from each of the entities offering the product for sale. Alternatively, the first computer system may be adapted to select one or more of the offers received from the plurality of second computer systems before the information containing the conditions is being passed to the potential purchasers. The system may be adapted to offer for sale a plurality of products, in which case the system is preferably adapted to receive a user selection of at least one of the products by a plurality of potential purchasers of the product.

Any and all of the features and functionalities described above in relation to the first aspect of the invention may be applied in the method according to the second aspect of the invention.

The invention further relates to a computer program for carrying out the method according to any of the claimed methods and being adapted to run on a computer system. The invention further relates to a computer readable data carrier loaded with a computer program according to the invention.

### BRIEF DESCRIPTION OF THE DRAWINGS

FIG. 1 shows an example of a map of an Internet site by means of which potential purchasers may place a request for an offer for a number of products,

FIG. 2 is a schematic illustration of the relationship between various entities involved in a preferred embodiment of the method of the invention,

FIG. 3 is a schematic illustration of an example of a sequence for placing a request for an offer for a product,

FIG. 4 is a schematic illustration of an example of a sequence of steps to be followed by a supplier of the product,

FIG. 5 is a schematic illustration of an example of an administration process.

### DETAILED DESCRIPTION OF THE DRAWINGS

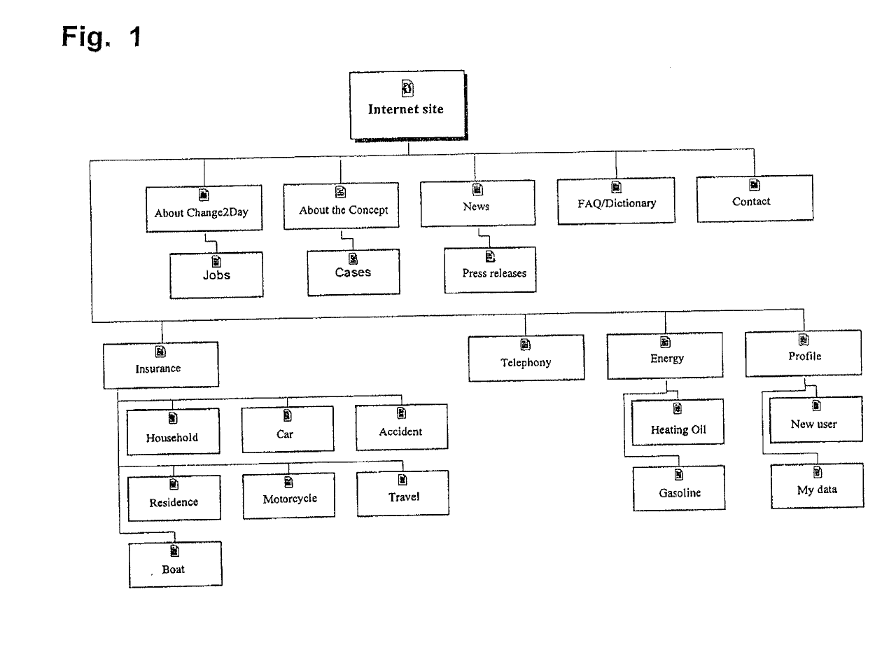

FIG. 1 shows an example of a map of an Internet site by means of which potential purchasers may place a request for an offer for a number of products. In the example shown in FIG. 1, the products offered for sale are:

Insurance products, including:

household value insurance,

vehicle insurance,

accident insurance,

residence insurance,

motorcycle insurance,

travel insurance,

boat insurance,

Telephone products,

Energy products, including:

heating oil,

gasoline.

The potential purchaser of one of the above products, i.e. an Internet user, may select one of the products by selecting an appropriate box or icon on the Internet site. By selecting the profile box or icon, the potential purchaser may register as a new user or amend previously stored data relating to him/her by clicking the “my data” box or icon.

By selecting one of the other boxes available at the site, the potential purchaser may gain access to information about the site, including job offers, information about the concept underlying the site, news, frequently asked questions, and information on how to contact the entity responsible for the site.

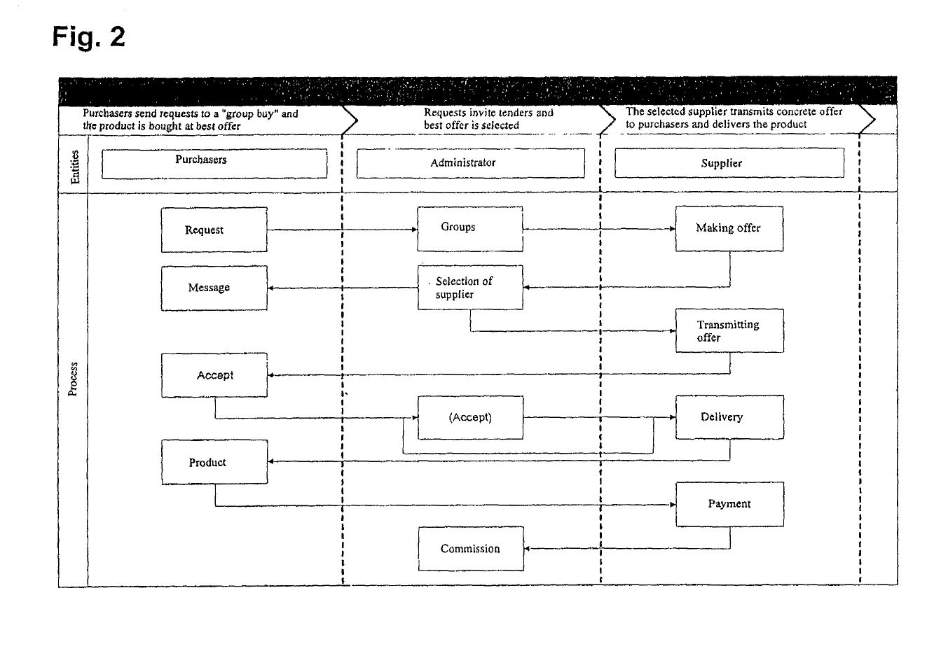

In a preferred embodiment, the system and the method of the invention involves a plurality of entities, as illustrated in FIG. 2, in which the steps involved in the process from requesting an offer for a product by a potential purchaser until a supplier has been selected and an offer has been made are displayed. Three entities are involved: purchaser, administrator and supplier. The purchaser is a person or entity having access to the site of FIG. 1 via the Internet, the computer system and software controlling the site being generally referred to as the “administrator. In the present context, the supplier entity comprises a second computer system connected to the site via the Internet. Via the Internet, the purchaser may send a request for an offer for the product to the administrator. The administrator generates groups of potential purchasers, and information on the groups and the requested product or products are sent to the supplier. At the supplier entity, an offer for sale is generated and sent back to the administrator. In case offers have been received from a plurality of suppliers, the administrator selects a supplier and sends a message to the purchasers indicating at least which supplier has been selected and possibly the conditions under which the product is offered for sale. In case only one offer from a single supplier has been received, the administrator selects that supplier. The administrator also sends a request to the selected supplier for sending an offer directly to the potential purchasers. Once the purchasers have accepted the offer, notice is given to the administrator and to the supplier, and the supplier delivers the product. In turn, the purchasers pay for the product, and a commission fee is paid by the supplier to the administrator.

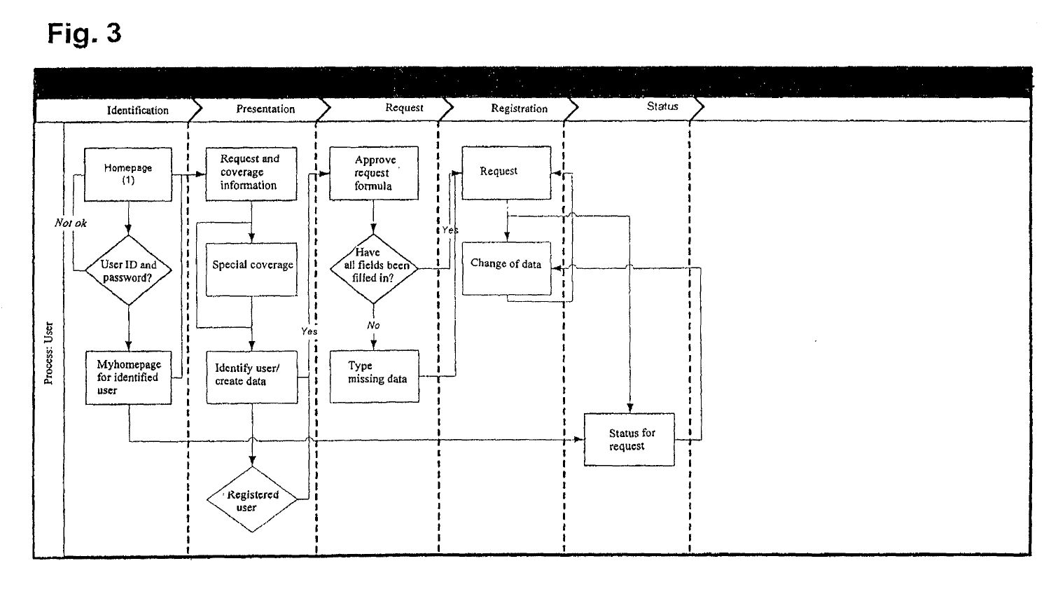

The step of sending a request for an offer is illustrated in detail in FIG. 3, the product for which an offer is requested being an insurance product. The process of sending of the request is divided into 5 sub-processes: identification, presentation, request, registration and status. At the Internet homepage of the administrator, a potential purchaser may enter a personal user identification code and password and gain access to previously stored personal data at “myhomepage”. The purchaser may gain access to or enter request and coverage data via the homepage or via myhomepage. From myhomepage, the purchaser may view the status on a previously transmitted request for an offer for an insurance product. At the status view, the purchaser may change previously entered data. At the presentation sub-process, the purchaser may gain access to or enter special coverage data and/or gain access to or enter user identification data. The purchaser is then being registered. At the request sub-process, the purchaser is requested to approve data inserted in a request formula. In the case that not all fields in the request formula have been filled in, the purchaser is prompted to fill in the missing data. Once all fields in the request formula have been filled in, the request is being registered.

At the presentation sub-process illustrated in FIG. 3, the purchaser is presented to available products which are described by short text streams. The purchaser selects a product and enters identification data and purchase-condition influencing data via menu dialogue boxes. The same applies to the step of changing of data in the registration subs process and the step of entering missing data in the request sub-process. At the registration sub-process, all entered data are displayed to the purchaser in a window. In the status sub-process, data related to a previously submitted request may be displayed to the purchaser in a window.

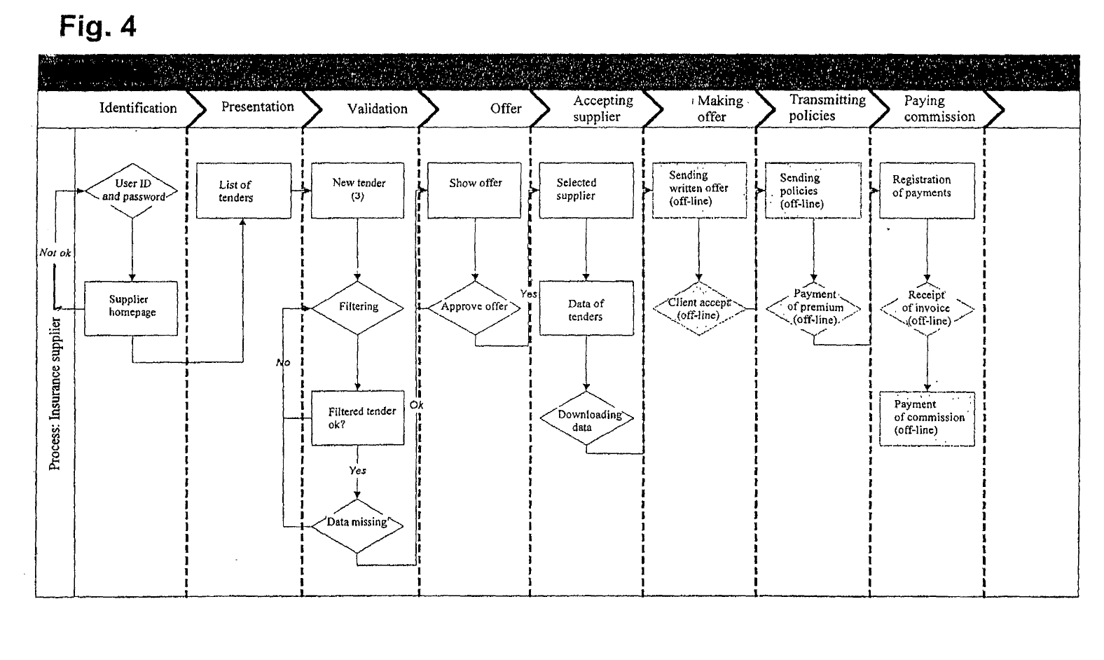

FIG. 4 is a schematic illustration of an example of a sequence of steps to be followed by a supplier of the product, in the following referred to as the “supplier process”. In the example of FIG. 4, the product is an insurance product. In the description of FIG. 4, an operator of the computer system of the supplier is referred to as “the supplier”. The operator may be a human or a computer. The supplier process comprises 8 sub-processes: identification, validation, offer, accepting supplier, making offer, transmitting policies, paying commission. At the identification sub-process, a supplier may gain access to a supplier homepage at the administrator's Internet site by entering a personal user identification code and password. At the presentation sub-process, the supplier is presented to a list of tenders. The supplier is presented to data relating to a new tender at the validation process, i.e. data relating to a new group of potential purchasers. The data shown may previously have been filtered by the administrator. The supplier may filter the purchasers so as to select, from the group of potential purchasers, a more limited group. Once all necessary data have been entered for the filtered group or filtered tender, an offer is displayed to the administrator. In case the offer is approved by the administrator, the supplier is being selected at the “accepting supplier” sub-process. Data related to a tender, i.e. to a group of purchasers and the requested products, are downloaded by the supplier who initiates that a written offer is sent to the potential purchasers of the group. The product is paid by the purchasers, i.e. the policyholders, paying an insurance premium. The payments are then registered, an invoice is received by the supplier who in turn pays a provision to the administrator.

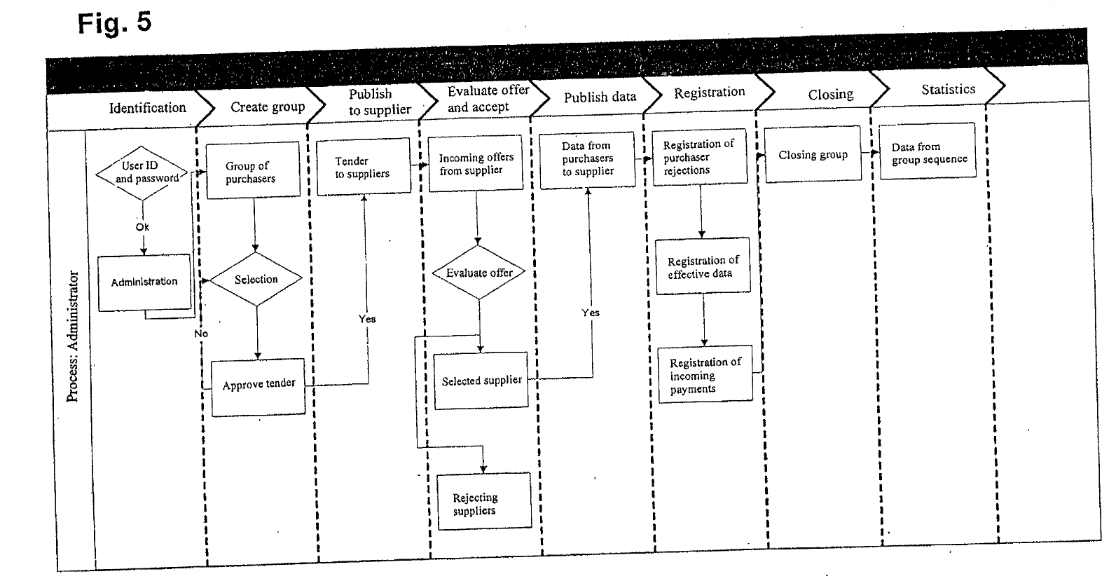

FIG. 5 is a schematic illustration of an example of an administration process comprising 8 sub-processes: identification, create group, publish to supplier, evaluate offer and accept offer, publish data, registration, closing, and statistics. In the example of FIG. 5, the computer system of the administrator or the operator thereof is generally referred to as “the administrator”. The administrator gains access to an administration homepage by entering a user identification code and a password. From the potential purchasers who have entered their identification data and purchase-condition influencing data, a group of purchasers is selected, and a tender is generated and approved. At the “publish to supplier” sub-process, the tender is submitted to the supplier(s). Then the offer(s) received from the suppliers is/are evaluated, and one supplier is selected. In case offers have been received from a plurality of suppliers, a rejection is transmitted to the supplier(s) not selected. At the “publish data” sub-process, data related to purchasers of a group are transmitted to the selected supplier. At the registration sub-process, possible rejections from potential purchasers are registered. Effective data, i.e. data of potential purchasers who have accepted the offer are registered, and incoming payments are registered as well. The group is then closed at the “closing” sub-process, and finally some statistics from the process is generated and displayed and/or stored. The statistics may, e.g., comprise data related to type of products, number of rejections from potential purchasers, number of acceptances from purchasers, prices, purchase-condition influencing data, etc.

1. A method for offering for sale of a product, the method being performed under the control of a first computer system connected to a computer network, the method comprising:
collecting, via the computer network, information from a plurality of potential purchasers of the product, the information including for each of the potential purchasers:
identification data identifying the purchaser,
purchase-condition influencing data influencing the conditions under which the product is going to be offered to the purchaser,
defining at least two groups of potential purchasers, the purchasers in each group having at least one purchase-condition influencing data in common,
generating, based at least on said common purchase-condition influencing data of each of the groups, at least one condition under which the product is offered for sale to the potential purchasers of each group,
forwarding information containing said at least one condition to each of the potential purchasers.

2. A method according to claim 1, wherein the steps of:
defining the groups of potential purchasers,
generating the at least one condition under which the product is offered for sale, and
forwarding information containing the at least one condition,
are performed when information from a first predetermined number of potential purchasers has been collected and/or when information has been collected for a first predetermined time interval, and wherein said steps are repeated when information from a second predetermined number of potential purchasers has been collected and/or when information has been collected for a second predetermined time interval.

3. A method according to claim 1 or 2, wherein the product is selected from the group consisting of an insurance, a telephone line, gasoline, heating oil, a loan, clothing, everyday necessities, books, electronic devices such as computers, entertainment electronics such as hifi devices or televesions, books, audio or video carrying media, and furniture.

4. A method according to any of claims 1-3, wherein said identification data comprises the name and the address of the potential purchaser.

5. A method according to any of claims 1-4, wherein the purchase-condition influencing data comprises data related to at least one of the following parameters: age of the potential purchaser, income, occupation, sex, marital status, number and age of children, address, creditability, property, past notifications of insurance claims, desired coverage of an insurance, number and kind of pets, type of vehicle, number of vehicles, value of vehicle(s), existing telephone service delivery entity, telephone number, telephone consumption, gasoline consumption, heating oil consumption, heating oil delivery entity, heating oil capacity of a home, location of a heating oil container at an address, desired delivery date of the product.

6. A method according to any of claims 1-5, wherein the at least one condition under which the product is offered for sale to the potential purchasers further comprises information related to at least one of the following: delivery date, delivery time, delivery period, obligation to terminate a delivery contract for the delivery of a competing product, deadline for placing a binding purchasing order.

7. A method according to any of claims 1-6, wherein the at least one common purchase-condition influencing data is defined by an interval.

8. A method according to any of claims 1-7, wherein the step of generating said at least one condition is performed by means of a second computer system connected to the computer network, the method further comprising:
subsequent to the step of defining the at least two groups and prior to the step of generating the at least one condition: passing to the second computer system information containing the number of purchasers in each group and the common purchase-condition influencing data,
receiving, at the first computer system, from the second system the at least one condition under which the product is offered for sale.

9. A method according to claim 8, wherein the second computer system is controlled by an entity offering said product for sale.

10. A method according to claim 9, wherein the method steps of claim 8 are performed at a plurality of second computer systems at a plurality of entities offering the product for sale.

11. A method according to claim 10, wherein the step of forwarding information containing said at least one condition to the potential purchasers comprises forwarding information containing conditions of each of the entities offering the product for sale.

12. A method according to claim 10, wherein the first computer system selects one of the offers received from the plurality of second computer systems before the information containing said condition is being passed to the potential purchasers.

13. A method for offering for sale of a plurality of products, the method being performed under the control of a first computer system connected to a computer network, the method comprising:
receiving a user selection of at least one of the products by a plurality of potential purchasers of the product, and
performing the method of any of claims 1-12 for each of the products.

14. A system for offering a product for sale, the system comprising a computer network and a first computer system connected to the computer network, the system being adapted to:
collect, via the computer network, information from a plurality of potential purchasers of the product, the information including for each of the potential purchasers:
identification data identifying the purchaser,
purchase-condition influencing data influencing the conditions under which the product is going to be offered to the purchaser,
define at least two groups of potential purchasers, the purchasers in each group having at least one purchase-condition influencing data in common,
generate, based at least on said common purchase-condition influencing data of each of the groups, at least one condition under which the product is offered for sale to the potential purchasers of each group,
forward information containing said at least one condition to each of the potential purchasers.

15. A system according to claim 14, the system being adapted to:
define the groups of potential purchasers,
generate the at least one condition under which the product is offered for sale, and
forward information containing the at least one condition,
when information from a first predetermined number of potential purchasers has been collected, the system comprising a data processor which is programmable to repeat defining, generating and forwarding when information from a second predetermined number of potential purchasers has been entered into the system.

16. A system according to claim 14 or 15, further comprising the features of any of claims 3-7.

17. A system according to any of claims 14-16, further comprising a second computer system connected to the computer network, the first computer system being adapted to:
pass, to the second computer system, information containing the number of purchasers in each group and the common purchase-condition influencing data,
receive, from the second computer system, the at least one condition under which the product is offered for sale.

18. A system according to claim 17, wherein the second computer system is controlled by an entity offering said product for sale.

19. A system according to claim 18, comprising a plurality a second computer systems at a plurality of entities offering the product for sale.

20. A system to claim 19, wherein the first computer system is adapted to forward, to the potential purchasers, information containing said conditions received from each of the entities offering the product for sale.

21. A system according to claim 19, wherein the first computer system is adapted to select one of the offers received from the plurality of second computer systems before the information containing said condition is being passed to the potential purchasers.

22. A system according to any of claims 14-21, the system being adapted to offer for sale a plurality of products, the system being adapted to receive a user selection of at least one of the products by a plurality of potential purchasers of the product.

23. A computer program for carrying out the method according to any of claims 1-12 or claim 13 and being adapted to run on a computer system.

24. A computer readable data carrier loaded with a computer program according to claim 23.
